(19) United States
(12) Patent Application Publication
(10) Pub. No.: US 2019/0013563 A1
(43) Pub. Date: Jan. 10, 2019

(54) CONNECTOR MODULE, COMMUNICATION CIRCUIT BOARD, AND ELECTRONIC DEVICE

(71) Applicant: SONY CORPORATION, Tokyo (JP)

(72) Inventors: Takahiro TAKEDA, Kanagawa (JP); Yasuhiro OKADA, Kanagawa (JP); Hiroyuki YAMAGISHI, Tokyo (JP); Kenichi KAWASAKI, Tokyo (JP)

(73) Assignee: Sony Corporation, Tokyo (JP)

(21) Appl. No.: 16/067,269

(22) PCT Filed: Jan. 6, 2017
(86) PCT No.: PCT/JP2017/000189

§ 371 Date: Jun. 29, 2018

(30) Foreign Application Priority Data
Jan. 20, 2016 (JP) 2016-009177

(51) Int. Cl. H01P 5/02; H01P 3/16

(52) U.S. Cl. CPC H01P 5/022; H01P 3/16

(57) ABSTRACT

The present disclosure relates to a connector module, a communication circuit board, and an electronic device that are capable of satisfactorily suppressing the leakage of high-frequency electromagnetic waves. The connector module includes an opening and a conductive spring. The opening accepts the insertion of an end of a waveguide that transmits high-frequency electromagnetic waves. The conductive spring locks the waveguide when the waveguide inserted into the opening is pressed toward one inner side surface of the opening. Further, the conductive spring is disposed in a gap between the opening and the waveguide so as to come into contact with the opening and with the waveguide along a direction in which the waveguide transmits the electromagnetic waves. The present technology is applicable, for example, to an electronic device that establishes communication by using millimeter waves.

### TECHNICAL FIELD

The present disclosure relates to a connector module, a communication circuit board, and an electronic device. More particularly, the present disclosure relates to a connector module, a communication circuit board, and an electronic device that are capable of satisfactorily suppressing the leakage of high-frequency electromagnetic waves.

### BACKGROUND ART

A system where millimeter waves, microwaves, and other high-frequency electromagnetic waves are transmitted with a waveguide cable generally requires a configuration for connecting the waveguide cable to a waveguide structure formed on a circuit board. In the past, the connection was established by using a dielectric waveguide-microstrip transition structure. The dielectric waveguide-microstrip transition structure is formed by securing a dielectric waveguide to the circuit board through a spacer. The dielectric waveguide includes a dielectric block having a surface entirely covered with a conductor film except for electromagnetic wave input/output sections and a slot formed on a bottom surface in an orthogonal direction relative to the direction of travel.

Further, as disclosed in PTL 1, the applicants of the present application have proposed an easily detachable waveguide connector structure that includes a small number of parts and is downsizable.

### CITATION LIST

### Patent Literature

### [PTL 1]

WO 15/049927 A1

### SUMMARY

### Technical Problem

However, the waveguide connector structure disclosed in PTL 1 described above requires a gap between a waveguide cable and a connector in order to make the waveguide cable detachable. Therefore, radio waves are likely to leak through the gap. Under these circumstances, there is a demand for a structure that is as easily detachable as before and capable of suppressing the leakage of radio waves in a more satisfactory manner than before.

The present disclosure has been made in view of the above circumstances, and makes it possible to satisfactorily suppress the leakage of high-frequency electromagnetic waves.

### Solution to Problem

According to an aspect of the present disclosure, there is provided a connector module including an opening and a locking member. The opening accepts the insertion of an end of a waveguide that transmits high-frequency electromagnetic waves. The locking member locks the waveguide when the waveguide inserted into the opening is pressed toward one inner side surface of the opening. The locking member includes a conductor and is disposed in a gap between the opening and the waveguide so as to come into contact with the opening and with the waveguide along a direction in which the waveguide transmits the electromagnetic waves.

According to another aspect of the present disclosure, there is provided a communication circuit board including a connector module. The connector module includes an opening and a locking member. The opening accepts the insertion of an end of a waveguide that transmits high-frequency electromagnetic waves. The locking member locks the waveguide when the waveguide inserted into the opening is pressed toward one inner side surface of the opening. The locking member includes a conductor and is disposed in a gap between the opening and the waveguide so as to come into contact with the opening and with the waveguide along a direction in which the waveguide transmits the electromagnetic waves.

According to still another aspect of the present disclosure, there is provided an electronic device including a communication circuit board. The communication circuit board includes a connector module and at least one of a transmission chip and a reception chip. The connector module includes an opening and a locking member. The opening accepts the insertion of an end of a waveguide that transmits high-frequency electromagnetic waves. The locking member locks the waveguide when the waveguide inserted into the opening is pressed toward one inner side surface of the opening. The locking member includes a conductor and is disposed in a gap between the opening and the waveguide so as to come into contact with the opening and with the waveguide along a direction in which the waveguide transmits the electromagnetic waves. The transmission chip performs a process of transmitting an electromagnetic wave that is transmitted by the waveguide through the connector module. The reception chip receives the electromagnetic wave that is transmitted by the waveguide through the connector module.

According to one aspect of the present disclosure, the waveguide is locked when the locking member presses the waveguide inserted into the opening toward one inner side surface of the opening, which accepts the insertion of the end of the waveguide transmitting high-frequency electromagnetic waves. Further, the locking member includes a conductor and is disposed in the gap between the opening and the waveguide so as to come into contact with the opening and with the waveguide along a direction in which the waveguide transmits the electromagnetic waves.

### Advantageous Effects of Invention

An aspect of the present disclosure satisfactorily suppresses the leakage of high-frequency electromagnetic waves.

### BRIEF DESCRIPTION OF DRAWINGS

FIG. 1 is a block diagram illustrating an exemplary configuration of an embodiment of a communication system to which the present technology is applied.

FIG. 2 is a perspective view illustrating an outline configuration of a connector module.

FIG. 3 is a diagram illustrating a cross-sectional structure of the connector module.

FIG. 4 are diagrams illustrating a detailed configuration of the connector module.

FIG. 5 is a diagram illustrating a first modification of the connector module.

FIG. 6 is a diagram illustrating a second modification of the connector module.

FIG. 7 is a diagram illustrating a third modification of the connector module.

FIG. 8 are diagrams illustrating the results of simulation for comparing a case where a conductive spring is included with a case where the conductive spring is excluded.

FIG. 9 are diagrams illustrating a configuration in which a plurality of conductive springs are disposed.

FIG. 10 are diagrams illustrating the results of simulation for comparing cases where the number of disposed conductive springs varies.

### DESCRIPTION OF EMBODIMENTS

Specific embodiments to which the present technology is applied will now be described in detail with reference to the accompanying drawings.

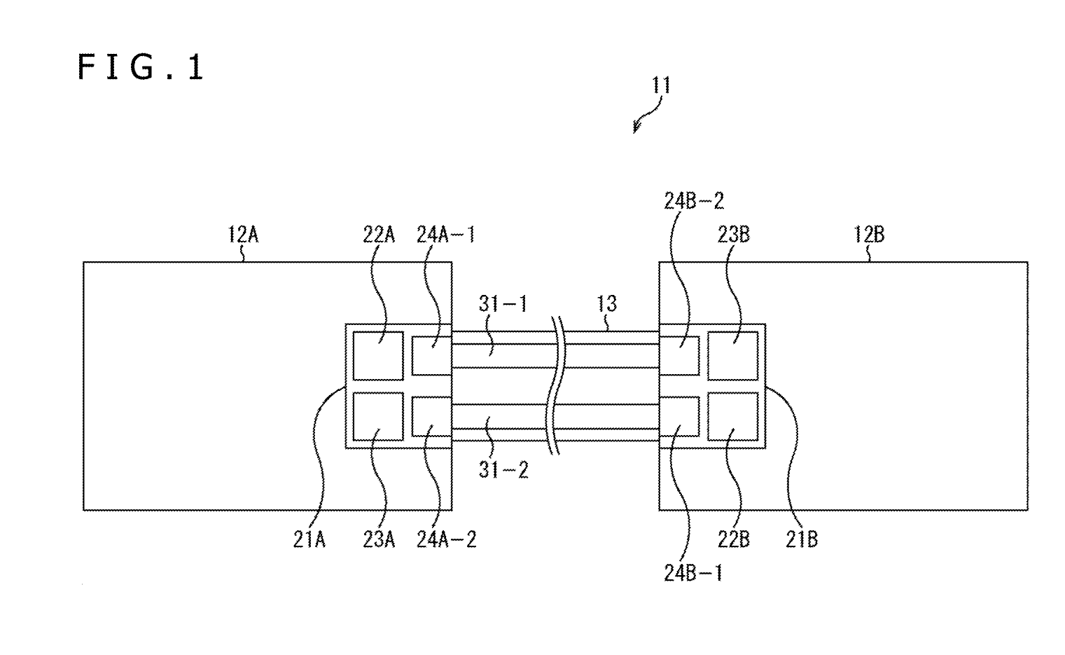

FIG. 1 is a block diagram illustrating an exemplary configuration of an embodiment of a communication system to which the present technology is applied.

As illustrated in FIG. 1, a communication system 11 is configured so that two electronic devices 12A and 12B are connected through a waveguide cable 13. The communication system 11 is capable of establishing communication by using electromagnetic waves (hereinafter referred to as the millimeter waves) within a frequency range of 30 to 300 GHz.

The electronic devices 12A and 12B respectively include communication circuit boards 21A and 21B having the similar configuration, and are able to perform high-speed signal transmission on the order of Gbps (e.g., 5 Gbps or higher) by using electromagnetic waves in a millimeter-wave band. For example, the electronic devices 12A and 12B are information terminals, such as so-called smartphones, and able to transfer large-capacity data, such as movie data, in a short period of time by establishing millimeter-wave band communication.

The waveguide cable 13 is integral with two parallelly disposed rectangular waveguides 31-1 and 31-2 and connects the electronic devices 12A and 12B. For example, the rectangular waveguide 31-1 is used to transmit millimeter waves from the electronic device 12A to the electronic device 12B, and the rectangular waveguide 31-2 is used to transmit millimeter waves from the electronic device 12B to the electronic device 12A. It should be noted that the waveguide cable 13 can be divided so as to be usable by the electronic devices 12A and 12B on an independent basis. The waveguide cable 13 is structured so that when the electronic devices 12A and 12B establish communication, the divided portions are connected at the point of division to form a single cable.

The communication circuit board 21A includes a transmission chip 22A, a reception chip 23A, and connector modules 24A-1 and 24A-2. Similarly, the communication circuit board 21B includes a transmission chip 22B, a reception chip 23B, and connector modules 24B-1 and 24B-2. It should be noted that the communication circuit board 21A and the communication circuit board 21B are similarly configured. When the communication circuit boards 21A and 21B need not be discriminated from each other, they will be simply referred to as the communication circuit boards 21. This also holds true for the components of the communication circuit boards 21.

The transmission chips 22 perform a process of converting a transmission target signal to a millimeter wave and transmitting the millimeter wave to the rectangular waveguides 31 through the connector modules 24-1.

The reception chips 23 perform a process of receiving a millimeter wave from the rectangular waveguides 31 through the connector modules 24-2 and restoring the millimeter wave to the original transmission target signal.

The connector modules 24-1 and 24-2 are configured so that the ends of the rectangular waveguides 31 are easily detachable, for example, with a specific jig or the like and not readily pulled out while the rectangular waveguides 31 are connected. Further, the connector modules 24-1 and 24-2 are configured so that the leakage of millimeter waves is prevented to suppress unnecessary radiation while the rectangular waveguides 31 are connected.

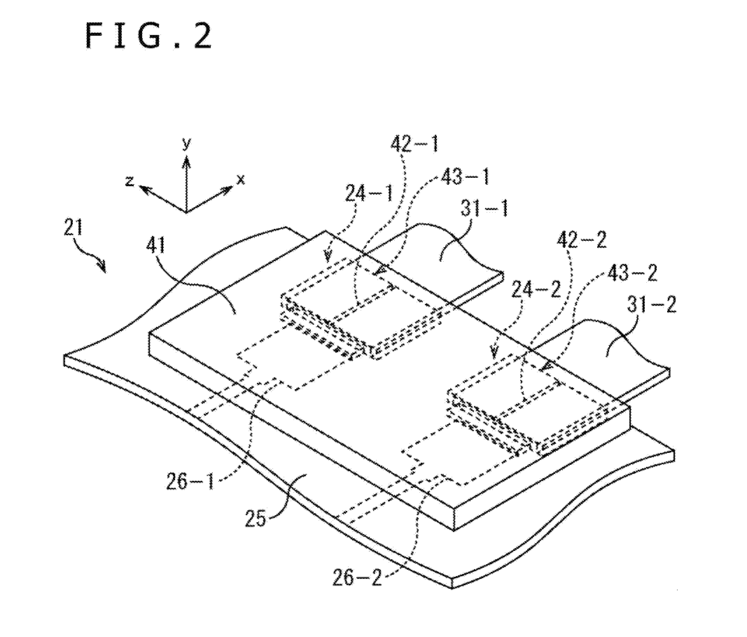

FIG. 2 is a perspective view illustrating an outline configuration of the connector modules 24-1 and 24-2.

As illustrated in FIG. 2, the connector modules 24-1 and 24-2 are configured so that the ends of the rectangular waveguides 31-1 and 31-2 can be respectively inserted into openings 43-1 and 43-2 while a conductive connector block 41 is secured to a dielectric circuit board 25 included in the communication circuit boards 21. In the exemplary configuration illustrated in FIG. 2, the connector modules 24-1 and 24-2 include one conductive connector block 41. Alternatively, however, two conductive connector blocks corresponding to the openings 43-1 and 43-2 may be used.

For example, the connector modules 24-1 are configured so as to form a predetermined gap with the rectangular waveguide 31-1 inserted into the opening 43-1 in order to make the rectangular waveguide 31-1 detachable from the opening 43-1. Therefore, the connector modules 24-1 is configured so that a conductive spring 42-1 is disposed to lock the rectangular waveguide 31-1 to the connector modules 24-1 and suppress the leakage of radio waves. Similarly, the connector module 24-2 is configured so that a conductive spring 42-2 is disposed.

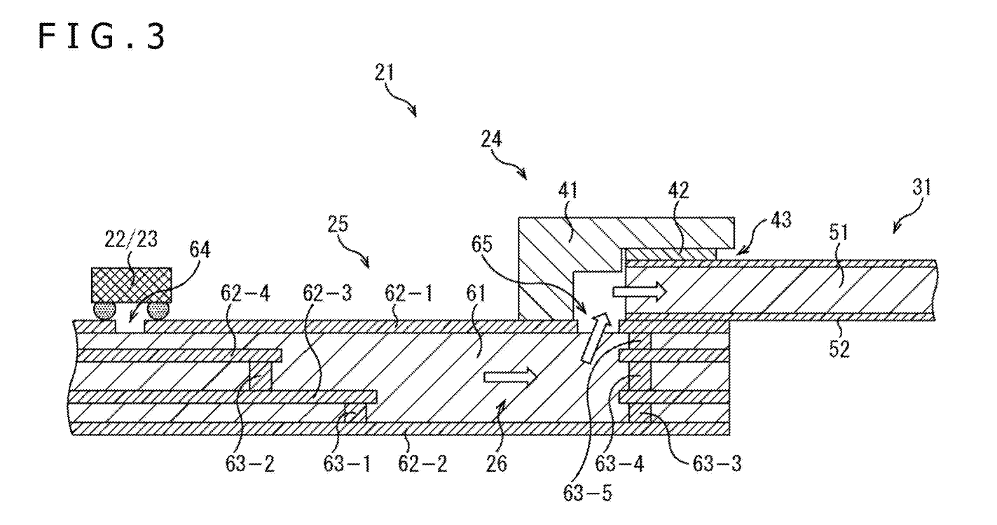

Further, a waveguide structure 26-1 for transmitting a millimeter wave from the transmission chips 22 to the connector modules 24-1 is formed in the dielectric circuit board 25. Additionally, a waveguide structure 26-2 for transmitting a millimeter wave from the connector modules 24-2 to the reception chips 23 is formed in the dielectric circuit board 25. For example, as described later with reference to FIG. 3, the dielectric circuit board 25 is configured so that the opposing surfaces of a dielectric are sandwiched between conductor layers while a plurality of vias are disposed along the outlines of the waveguide structures 26 so as to couple the conductor layers. As described above, the dielectric circuit board 25 is configured so that the waveguide structures 26 include a structure enclosed by the conductor layers and vias.

It should be noted, as illustrated in FIG. 2, that a direction in which the rectangular waveguides 31 and the waveguide structures 26 transmit electromagnetic waves is hereinafter referred to as the x-direction, and that a direction perpendicular to the principal plane of the dielectric circuit board 25 is hereinafter referred to as the y-direction, and further that the width direction of the dielectric circuit board 25 is hereinafter referred to as the z-direction.

FIG. 3 is a diagram illustrating an x-y cross-sectional structure of the connector modules 24 depicted in FIG. 2.

As illustrated in FIG. 3, the connector modules 24 are configured so that the openings 43, which are open in the x-direction, are disposed with the conductive connector block 41 secured to the upper surface of the dielectric circuit board 25. Further, the connector modules 24 are configured so that the rectangular waveguides 31 are pressed against the dielectric circuit board 25 by the conductive springs 42 disposed between the conductive connector block 41 and the rectangular waveguides 31 while the ends of the rectangular waveguides 31 are inserted into the openings 43.

The rectangular waveguides 31 are formed so that the upper and lower surfaces and both lateral surfaces of a dielectric 51, which is shaped like a rectangle, are surrounded by conductive layers 52, and that the conductive layers 52 are open only for the leading end face of the dielectric 51. It should be noted that the rectangular waveguides 31 are configured so that the dielectric 51 is filled into the above-described cylindrical conductive layers 52. However, an alternative structure may be adopted so that the conductive layers 52 have a hollow interior.

The dielectric circuit board 25 is structured so that a conductor layer 62-1 is formed on the upper surface of a dielectric 61 and that a conductor layer 62-2 is formed on the lower surface of the dielectric 61. Further, a plurality of conductor layers may be disposed between the conductor layers 62-1 and 62-2. In the example of FIG. 3, conductor layers 62-3 and 62-4 are disposed. As described above with reference to FIG. 2, a plurality of vias 63 for forming the waveguide structures 26 (vias 63-1 to 63-5 in the exemplary configuration depicted in FIG. 3) are disposed to penetrate between the conductor layers 62.

Further, the dielectric circuit board 25 is configured so that a hole 64 is formed in the conductor layer 62-1 in correspondence with a place where the transmission chips 22 or the reception chips 23 are disposed, and that a hole 65 is formed in the conductor layer 62-1 so as to be open toward the opening 43 in the conductive connector block 41. For example, electromagnetic waves outputted from the transmission chips 22 are passed through the hole 64 and then along the waveguide structures 26 in the dielectric circuit board 25, and transmitted as indicated by white arrows. Subsequently, the electromagnetic waves are outputted to the opening 43 in the conductive connector block 41 through the hole 65 and transmitted inward from the end face of the rectangular waveguides 31.

The conductive connector block 41 may be entirely formed by a conductor, but is a member whose surface acting as the opening 43 is at least covered with a conductor.

The conductive springs 42 include a conductor. The conductive springs 42 lock the rectangular waveguides 31 when the rectangular waveguides 31 inserted into the opening 43 are pressed against the dielectric circuit board 25. In other words, the conductive layers 52 of the rectangular waveguides 31 come into surface contact with the conductor layer 62-1 of the dielectric circuit board 25 due to the elastic force of the conductive springs 42. Then, as depicted in the drawing, the conductive springs 42 positioned in a gap between the opening 43 and the rectangular waveguides 31 are disposed so as to come into contact with the opening 43 and the rectangular waveguides 31 along a direction in which the rectangular waveguides 31 transmit electromagnetic waves.

The connector modules 24 are configured as described above and structured so that the conductive springs 42 come into contact with the opening 43 and the rectangular waveguides 31 along the direction in which the rectangular waveguides 31 transmit electromagnetic waves. Therefore, even when a gap is provided between the opening 43 and the rectangular waveguides 31, the cutoff frequency of the gap can be raised to satisfactorily suppress the leakage of radio waves.

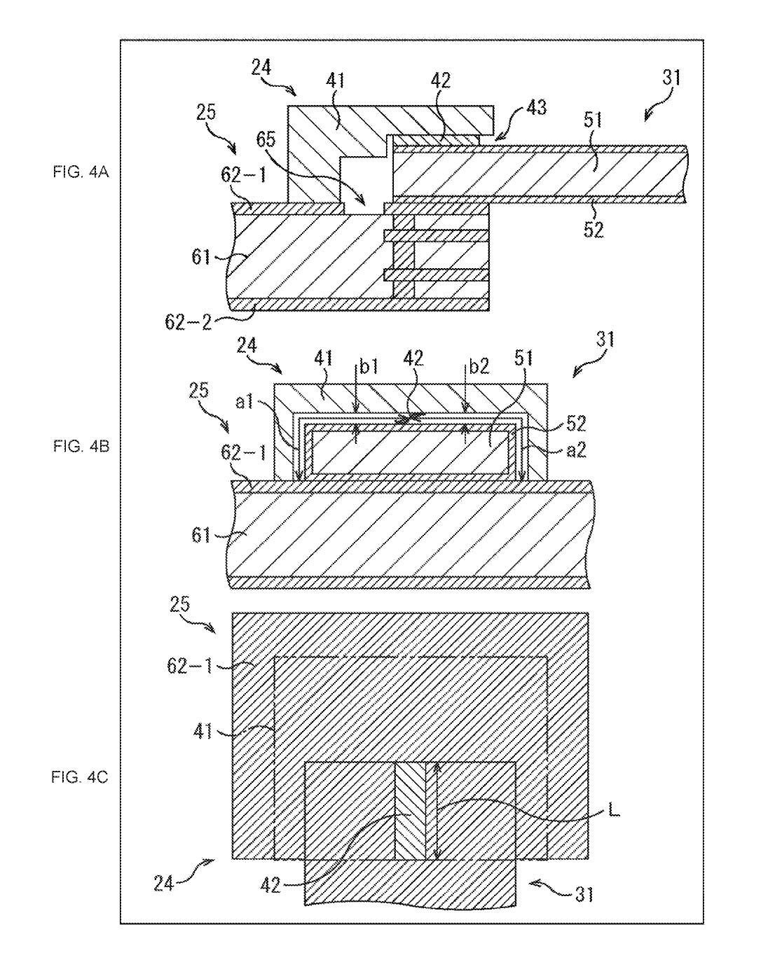

The configuration of the connector modules 24 will now be further described with reference to FIG. 4.

As is the case with FIG. 3, FIG. 4A illustrates an x-y cross-sectional structure of the connector modules 24. Further, FIG. 4B illustrates a y-z cross-sectional structure of the connector modules 24. FIG. 4C illustrates an outline configuration of the connector modules 24 as viewed in the y-direction.

As depicted, for example, in FIG. 4B, the conductive springs 42 are disposed at the center in the width direction (z-direction in FIG. 2) of the rectangular waveguides 31 so as to divide a gap between the conductive connector block 41 and the rectangular waveguides 31 into two as viewed in a direction (x-direction in FIG. 2) in which the electromagnetic waves are transmitted. Along this gap, the length between one conductor layer 62-1 and the conductive springs 42 is referred to as the width a1, and the length between the other conductor layer 62-1 and the conductive springs 42 is referred to as the width a2. Further, the gap length between the conductor layer 62-1 in the region of the width a1 and the conductive springs 42 is referred to as the interval b1, and the gap length between the conductor layer 62-1 in the region of the width a2 and the conductive springs 42 is referred to as the interval b2.

Here, the cutoff frequency fc in the basic mode (TE10) of the rectangular waveguides 31 is determined from Equation (1) below, where a is the width, εᵣ is the dielectric constant, and c is the light speed.

$$\begin{matrix}[ Math . 1 ] & \\ fc = \frac{c}{2 a \sqrt{{ɛ}_{r}}} & ( 1 )\end{matrix}$$

As indicated in Equation (1), the smaller the width a of the gap, the higher the cutoff frequency and thus the more difficult it is to propagate a low frequency. It should be noted that, preferably, the thickness of the conductive springs 42 is greater than the thickness of the conductor layer 62-1 of the dielectric circuit board 25.

Consequently, it is desirable that each of the widths a1 and a2 along the gap between the conductive connector block 41 and the rectangular waveguides 31 be designed to be, for example, not greater than half the wavelength. Further, it is desirable that the interval b1 be designed to be not greater than half the width a1, and that the interval b2 be designed to be not greater than half the width a2.

Moreover, as indicated in FIG. 4C, it is desirable that the length L of the conductive springs 42 along the direction (x-direction in FIG. 2) in which the electromagnetic waves are transmitted be designed to be not less than half the wavelength. It should be noted that the length L of the conductive springs 42 may be set as appropriate in accordance with a determined attenuation.

When the gap between the conductive connector block 41 and the rectangular waveguides 31 and the dimensions of the conductive springs 42 are set as described above, it is possible to implement the connector modules 24 that are capable of satisfactorily suppressing the leakage of radio waves.

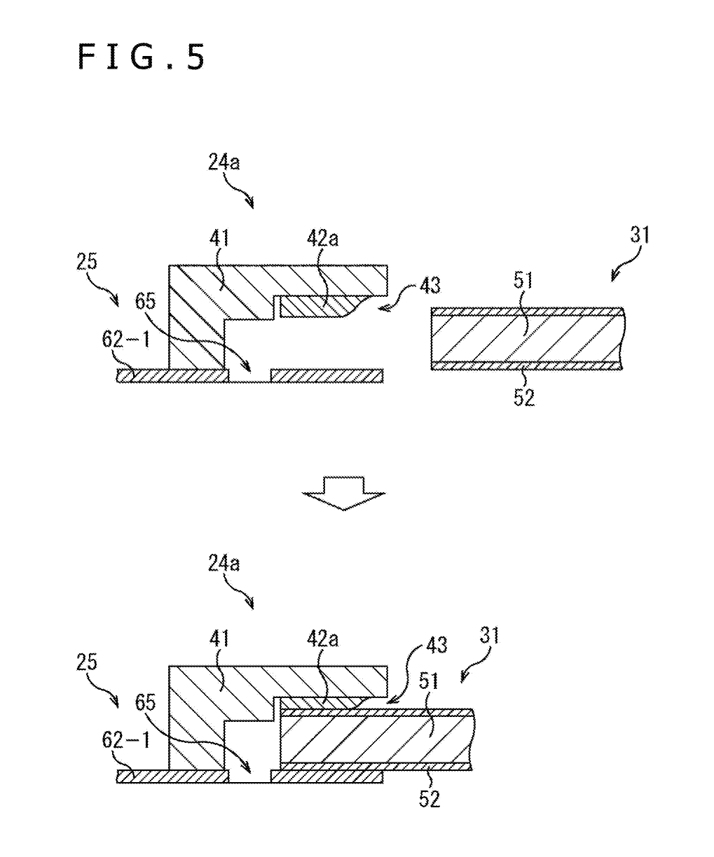

FIG. 5 is a diagram illustrating a first modification of the connector modules 24.

As illustrated in the upper half of FIG. 5, the connector module 24a is configured so that the conductive spring 42a is secured to the inside of the opening 43 in the conductive connector block 41. Further, the configuration of the connector module 24a differs from the configuration of the connector module 24 depicted in FIG. 3 in that the conductive spring 42a is tapered. More specifically, the y-direction height of the conductive spring 42a gradually decreases toward the inlet of the opening 43 (i.e., a decrease occurs in the length of the conductive spring 42a in the interval direction of the gap between the conductive connector block 41 and the rectangular waveguides 31).

As illustrated in the lower half of FIG. 5, the connector module 24a configured as described above can be structured so that the rectangular waveguides 31 can easily be inserted into the opening 43.

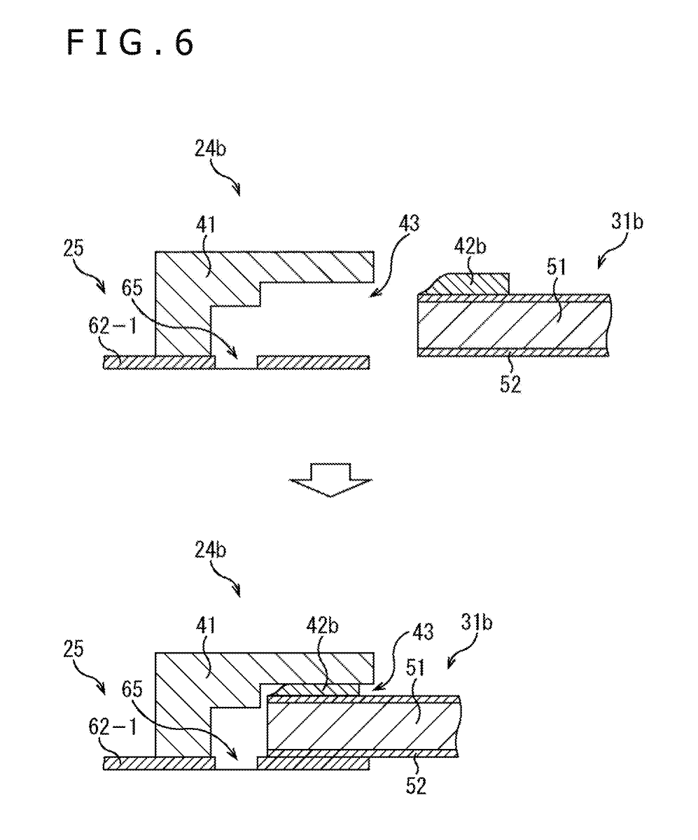

Next, FIG. 6 is a diagram illustrating a second modification of the connector modules 24.

As illustrated in the upper half of FIG. 6, the connector module 24b is configured so that the conductive spring 42b is secured to the vicinity of the leading end of the rectangular waveguide 31b. Further, the configuration of the connector module 24b differs from the configuration of the connector module 24 depicted in FIG. 3 in that the conductive spring 42b is tapered. More specifically, the y-direction height of the conductive spring 42b gradually decreases toward the leading end of the rectangular waveguide 31b (i.e., a decrease occurs in the length of the conductive spring 42b in the interval direction of the gap between the conductive connector block 41 and the rectangular waveguide 31b).

As illustrated in the lower half of FIG. 6, the connector module 24b configured as described above can be structured so that the rectangular waveguide 31b can easily be inserted into the opening 43.

As described above with reference to FIGS. 5 and 6, the connector modules 24 can be configured to permit the conductive springs 42 to be secured to either the conductive connector block 41 or the rectangular waveguides 31.

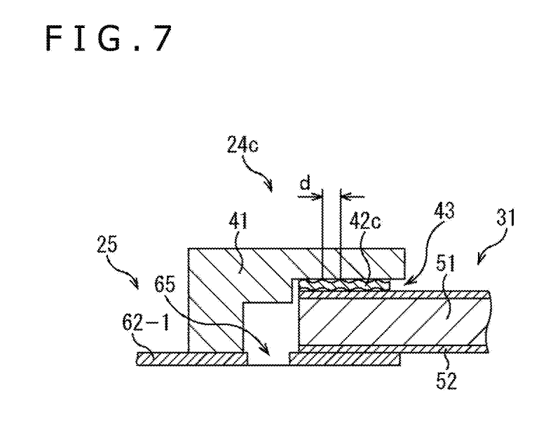

Next, FIG. 7 is a diagram illustrating a third modification of the connector modules 24.

As illustrated in FIG. 7, the configuration of the connector module 24c differs from the configuration of the connector module 24 of FIG. 3 in that the conductive spring 42c comes into partial contact with the rectangular waveguides 31 along their longitudinal direction (i.e., the direction in which the rectangular waveguides 31 transmit electromagnetic waves). In other words, the conductive spring 42c need not be in complete contact with the rectangular waveguides 31 along its longitudinal direction.

For example, the connector module 24c may be configured so that the interval d between contact points at which the conductive spring 42c is in contact with the conductive connector block 41 and the rectangular waveguides 31 is sufficiently shorter than the wavelength of a transmitted electromagnetic wave (d<<wavelength). This ensures that the leakage of radio waves can be sufficiently suppressed. More specifically, when the wavelength is approximately 5 mm, it is preferable that the interval d between the contact points be not greater than 0.5 mm. For example, when the adopted configuration is such that the conductive springs 42 are in complete contact along the longitudinal direction, a great gap may occur. However, when the conductive spring 42c is adopted, it is possible to avoid a situation where a gap greater than the interval d occurs. This makes it possible to prevent the leakage of radio waves, which may occur when such a great gap occurs.

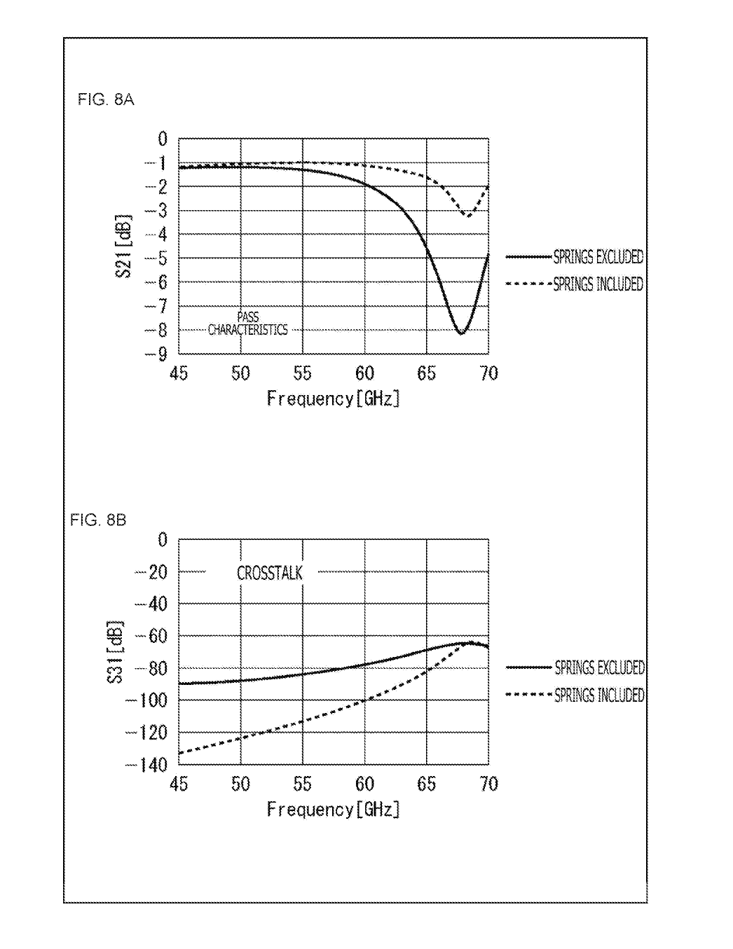

Next, FIG. 8 illustrate the results of simulation for comparing a case where the conductive springs 42 are included with a case where the conductive springs 42 are excluded.

FIG. 8A illustrates the results of simulation of pass characteristics of the connector modules 24 depicted, for example, in FIG. 3 by comparing a configuration including the conductive springs 42 with a configuration excluding the conductive springs 42.

FIG. 8A indicates that a structure including the conductive springs 42 improves the pass characteristics. More specifically, the pass characteristics are improved so that a dip in the vicinity of 68 GHz is changed from approximately −8 dB to approximately −3 dB. It should be noted that intervals at which the dip appears are determined, for example, by the size of the gap.

Further, FIG. 8B illustrates the results of simulation of crosstalk in a configuration where the connector modules 24-1 and 24-2 depicted, for example, in FIG. 2 are disposed adjacent to each other.

FIG. 8B indicates that the crosstalk of the connector modules 24 having the conductive springs 42 is improved. More specifically, the crosstalk at 60 GHz is improved by as much as approximately 20 dB.

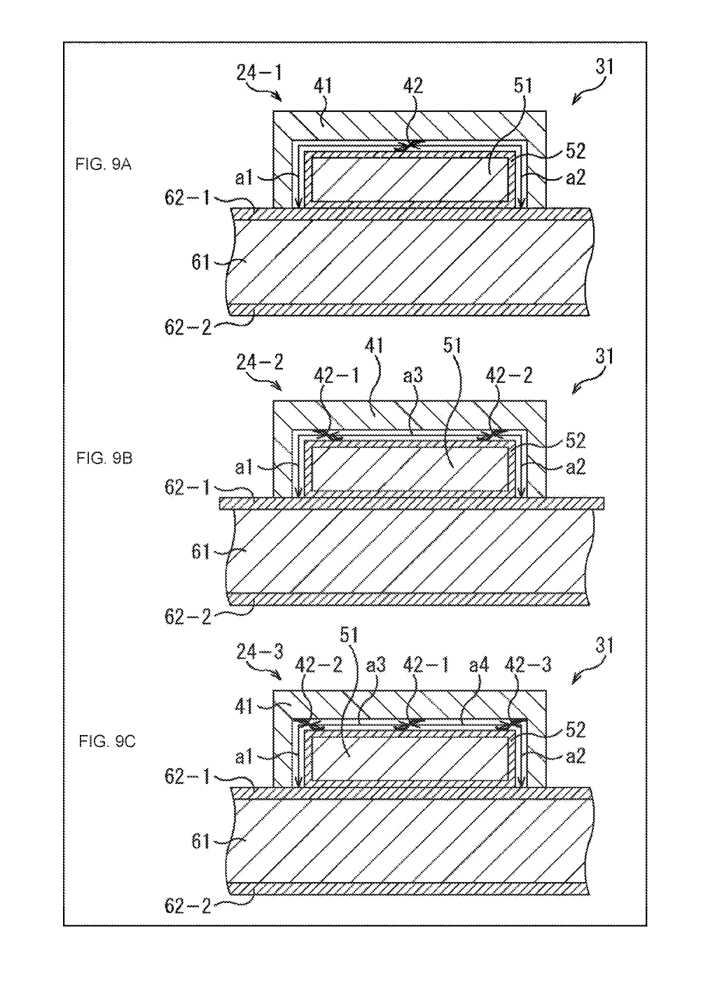

A configuration where a plurality of conductive springs 42 are disposed in the gap between the opening 43 and the rectangular waveguides 31 will now be described with reference to FIG. 9.

FIG. 9A illustrates the connector module 24-1 having one conductive spring 42, as is the case with FIG. 4B. Further, FIG. 9B illustrates the connector module 24-2 having two conductive springs 42-1 and 42-2. FIG. 9C illustrates the connector module 24-3 having three conductive springs 42-1, 42-2 and 42-3.

When the adopted configuration is such that the conductive springs 42 are disposed at a plurality of points as described above, it is possible to decrease the width a of the gap between the opening 43 and the rectangular waveguides 31. Consequently, the cutoff frequency can be raised to improve the effect of suppressing the leakage of electromagnetic waves.

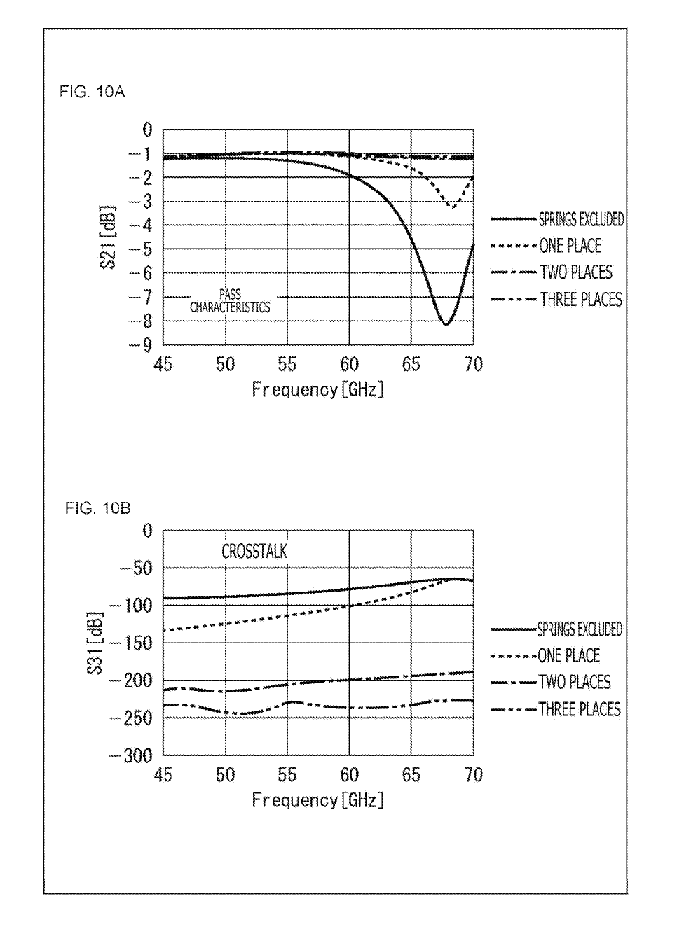

FIG. 10 illustrate the results of simulation for comparing cases where the number of disposed conductive springs 42 varies.

FIG. 10A illustrates the results of simulation of pass characteristics by comparing a configuration excluding the conductive springs 42 with the configurations of the connector modules 24-1 to 24-3 depicted in FIG. 9. Further, FIG. 10B illustrates the results of simulation of crosstalk by comparing a configuration excluding the conductive springs 42 with the configurations of the connector modules 24-1 to 24-3 depicted in FIG. 9.

FIG. 10 indicate that the pass characteristics and crosstalk are both improved by increasing the number of disposed conductive springs 42.

For example, the crosstalk at 60 GHz is approximately −80 dB in the configuration excluding the conductive springs 42, but is improved to approximately −100 dB in the connector module 24-1 having one conductive spring 42. Further, the crosstalk at 60 GHz is improved to approximately −200 dB (not greater than a detection limit) in the connector module 24-2 having two conductive springs 42-1 and 42-2, and is improved to approximately −240 dB (not greater than the detection limit) in the connector module 24-3 having three conductive springs 42-1 to 42-3.

Furthermore, the dip level of propagation characteristics in the vicinity of 68 GHz is approximately −8 dB in the configuration excluding the conductive springs 42, but is improved to approximately −3 dB in the connector module 24-1 having one conductive spring 42. Further, in the connector module 24-2 having two conductive springs 42-1 and 42-2 and in the connector module 24-3 having three conductive springs 42-1, 42-2 and 42-3, the dip level of propagation characteristics in the vicinity of 68 GHz is further improved so that no dip occurs.

It should be noted that the rectangular waveguides 31 are inserted into the connector modules 24 during a process of assembling the communication circuit boards 21. Under normal conditions, users of the electronic devices 12 do not insert or remove the rectangular waveguides 31. Further, the rectangular waveguides 31 should be structured so as not to be easily removable from the connector modules 24. In need of repairs, the rectangular waveguides 31 can be repaired by using a special jig or replaced together with the communication circuit boards 21.

Meanwhile, when the adopted structure is such that the rectangular waveguides 31 are to be locked by means of contact in the gap between the opening 43 and the rectangular waveguides 31, it is possible to use, for example, metal conductive springs 42 or conductive rubber. In other words, it is desirable to use a locking member that facilitates the insertion and removal of the rectangular waveguides 31.

As described above, the connector modules 24 can satisfactorily prevent the leakage of electromagnetic waves from a portion to which the rectangular waveguides 31 are connected. This makes it possible to comply, for example, with the requirements of the Radio Act. Additionally, for example, generation of crosstalk and deterioration of pass characteristics can be avoided to prevent degradation of signal quality.

It should be noted that the present technology may adopt the following configurations.

(1)

A connector module including:

an opening that accepts insertion of an end of a waveguide for transmitting high-frequency electromagnetic waves; and

a locking member that locks the waveguide when the waveguide inserted into the opening is pressed toward one inner side surface of the opening,

in which the locking member includes a conductor and is disposed in a gap between the opening and the waveguide so as to come into contact with the opening and with the waveguide along a direction in which the waveguide transmits the electromagnetic waves.

(2)

The connector module as described in (1) above, in which a longitudinal length of the locking member coming into contact with the opening and with the waveguide along the direction in which the waveguide transmits the electromagnetic waves is not less than half the wavelength of radio waves transmitted by the waveguide.

(3)

The connector module as described in (1) or (2) above, in which the locking member is secured to an inside of the opening and tapered so that the length of the locking member in an interval direction of the gap gradually decreases toward an inlet of the opening into which the waveguide is to be inserted.

(4)

The connector module as described in (1) or (2) above, in which the locking member is secured to a vicinity of an end of the waveguide and tapered so that the length of the locking member in an interval direction of the gap gradually decreases toward a leading end of the waveguide.

(5)

The connector module as described in any one of (1) to (4) above, in which the locking member is formed so as to come into partial contact with the opening and with the waveguide at a plurality of points along the direction in which the waveguide transmits the electromagnetic waves.

(6)

The connector module as described in any one of (1) to (5) above, in which a plurality of pieces of the locking member are disposed in the gap between the opening and the waveguide.

(7)

A communication circuit board including:

a connector module,

the connector module including
an opening that accepts insertion of an end of a waveguide for transmitting high-frequency electromagnetic waves, and
a locking member that locks the waveguide when the waveguide inserted into the opening is pressed toward one inner side surface of the opening,
in which the locking member includes a conductor and is disposed in a gap between the opening and the waveguide so as to come into contact with the opening and with the waveguide along a direction in which the waveguide transmits the electromagnetic waves.

(8)

The communication circuit board as described in (7) above, further including:

at least one of a transmission chip and a reception chip, the transmission chip performing a process of transmitting an electromagnetic wave that is transmitted by the waveguide through the connector module, the reception chip receiving the electromagnetic wave that is transmitted by the waveguide through the connector module.

(9)

An electronic device including:

a communication circuit board that includes a connector module and at least one of a transmission chip and a reception chip;

the connector module including
an opening that accepts insertion of an end of a waveguide for transmitting high-frequency electromagnetic waves, and
a locking member that locks the waveguide when the waveguide inserted into the opening is pressed toward one inner side surface of the opening,
in which the locking member includes a conductor and is disposed in a gap between the opening and the waveguide so as to come into contact with the opening and with the waveguide along a direction in which the waveguide transmits the electromagnetic waves;

the transmission chip performing a process of transmitting an electromagnetic wave that is transmitted by the waveguide through the connector module;

the reception chip receiving the electromagnetic wave that is transmitted by the waveguide through the connector module.

It is to be understood that the present embodiment is not limited to the above-described embodiments, and that various modifications may be made without departing from the spirit and scope of the present disclosure.

### REFERENCE SIGNS LIST

11 Communication system, 12 Electronic device, 13 Waveguide cable, 21 Communication circuit board, 22 Transmission chip, 23 Reception chip, 24 Connector module, 25 Dielectric circuit board, 26 Waveguide structure, 31 Rectangular waveguide, 41 Conductive connector block, 42 Conductive spring, 43 Opening, 51 Dielectric, 52 Conductive layer, 61 Dielectric, 62 Conductor layer, 63 Via, 64, 65 Hole

1. A connector module comprising:
an opening that accepts insertion of an end of a waveguide for transmitting high-frequency electromagnetic waves; and
a locking member that locks the waveguide when the waveguide inserted into the opening is pressed toward one inner side surface of the opening,
wherein the locking member includes a conductor and is disposed in a gap between the opening and the waveguide so as to come into contact with the opening and with the waveguide along a direction in which the waveguide transmits the electromagnetic waves.

2. The connector module according to claim 1, wherein a longitudinal length of the locking member coming into contact with the opening and with the waveguide along the direction in which the waveguide transmits the electromagnetic waves is not less than half the wavelength of radio waves transmitted by the waveguide.

3. The connector module according to claim 1, wherein the locking member is secured to an inside of the opening and tapered so that the length of the locking member in an interval direction of the gap gradually decreases toward an inlet of the opening into which the waveguide is to be inserted.

4. The connector module according to claim 1, wherein the locking member is secured to a vicinity of an end of the waveguide and tapered so that the length of the locking member in an interval direction of the gap gradually decreases toward a leading end of the waveguide.

5. The connector module according to claim 1, wherein the locking member is formed so as to come into partial contact with the opening and with the waveguide at a plurality of points along the direction in which the waveguide transmits the electromagnetic waves.

6. The connector module according to claim 1, wherein a plurality of pieces of the locking member are disposed in the gap between the opening and the waveguide.

7. A communication circuit board comprising:
a connector module,
the connector module including
an opening that accepts insertion of an end of a waveguide for transmitting high-frequency electromagnetic waves, and
a locking member that locks the waveguide when the waveguide inserted into the opening is pressed toward one inner side surface of the opening,
wherein the locking member includes a conductor and is disposed in a gap between the opening and the waveguide so as to come into contact with the opening and with the waveguide along a direction in which the waveguide transmits the electromagnetic waves.

8. The communication circuit board according to claim 7, further comprising:
at least one of a transmission chip and a reception chip, the transmission chip performing a process of transmitting an electromagnetic wave that is transmitted by the waveguide through the connector module, the reception chip receiving the electromagnetic wave that is transmitted by the waveguide through the connector module.

9. An electronic device comprising:
a communication circuit board that includes a connector module and at least one of a transmission chip and a reception chip;
the connector module including
an opening that accepts insertion of an end of a waveguide for transmitting high-frequency electromagnetic waves, and
a locking member that locks the waveguide when the waveguide inserted into the opening is pressed toward one inner side surface of the opening,
wherein the locking member includes a conductor and is disposed in a gap between the opening and the waveguide so as to come into contact with the opening and with the waveguide along a direction in which the waveguide transmits the electromagnetic waves;
the transmission chip performing a process of transmitting an electromagnetic wave that is transmitted by the waveguide through the connector module;
the reception chip receiving the electromagnetic wave that is transmitted by the waveguide through the connector module.
